(19) United States
(12) Patent Application Publication
(10) Pub. No.: US 2006/0252396 A1
(43) Pub. Date: Nov. 9, 2006

(54) Phase generator using polyphase architecture

(75) Inventors: Ilan Saul Barak, Kfar Saba (IL); Chu-Hsiung Ho, Milpitas, CA (US)

Correspondence Address: NIXON & VANDERHYE, PC, 901 NORTH GLEBE ROAD, 11TH FLOOR, ARLINGTON, VA, 22203, US

(73) Assignee: DSPG LTD., Herzliya (IL)

(21) Appl. No.: 11/124,140

(22) Filed: May 9, 2005

(51) Int. Cl. H04B 1/40; H04B 1/06; H04B 7/00

(52) U.S. Cl. 455/259; 455/76

(57) ABSTRACT

A phase generator includes at least one input port for accepting a reference signal having a frequency, a plurality of n output ports, n>4, and a network of phase-shifting elements coupled in a circularly-symmetrical configuration between the at least one input port and the output ports. The network of phase-shifting elements has a symmetry increment of 360/n degrees. The phase generator generates at the output ports respective polyphase signals at the frequency, the polyphase signals having respective phases that are consecutive integer multiples of 360/n degrees.

### FIELD OF THE INVENTION

The present invention relates generally to RF integrated circuits, and particularly to methods and devices for generating multiple-phase signals using polyphase architecture.

### BACKGROUND OF THE INVENTION

Polyphase signals, i.e., groups of signals having multiple phases at a common frequency, are used for a variety of RF (Radio Frequency) and communications applications.

Polyphase signals are often used as local-oscillator (LO) signals for frequency up-conversion and down-conversion. For example, Sheng et al., in a paper entitled “A Wide-Bandwidth Si/SiGe HBT Direct Conversion Sub-Harmonic Mixer/Downconverter,” IEEE Journal of Solid-State Circuits (35:9), September 2000, pages 1329-1337, which is incorporated herein by reference, describe a wideband sub-harmonic mixer/direct-conversion down-converter implemented in a Si/SiGe HBT technology. The circuit utilizes a combination of phase shifters operating at 45° and 90°.

The use of RC (resistive-capacitive) networks for generation of polyphase LO signals are described by Galal et al., in a paper entitled “RC Sequence Asymmetric Polyphase Networks for RF Integrated Transceivers,” IEEE Transactions on Circuits and Systems-II: Analog and Digital Signal Processing (47:1), January 2000, pages 18-27, which is incorporated herein by reference.

Koh et al., in a paper entitled “Subharmonically Pumped CMOS Frequency Conversion (Up and Down) Circuits for 2-GHz WCDMA Direct-Conversion Transceiver,” IEEE Journal of Solid-State Circuits (39:6), June 2004, pages 871-884, which is incorporated herein by reference, describe quadrature sub-harmonic mixers that operate in quadrature double-balanced mode. The mixers require local oscillator (LO) signals with octet-phases (0°, 45°, 90°, 135°, 180°, 225°, 270° and 315°) , which are produced by an active multiphase LO generator composed of a polyphase filter and active 45° phase shifting circuits.

Polyphase networks comprise multiple inputs and multiple outputs and are designed to manipulate the input signals to provide desired polyphase output signals. Networks of this sort are sometimes used for generating polyphase signals. For example, asymmetric polyphase networks are described in the paper by Galal et al., cited above. The general behavior of asymmetric polyphase networks is discussed and analyzed, as well as their distinct property of discriminating between positive and negative sequences. A design methodology is proposed and a sensitivity analysis based on Monte Carlo simulation is presented. The effect of the absolute variation of resistance and capacitance values on the phase and gain matching, as well as on the image signal suppression, is also investigated for one-, two-, and three-stage networks.

An eight-phase phase splitter is described in U.S. Pat. No. 6,388,543, whose disclosure is incorporated herein by reference. The inventors describe an eight-phase 45° polyphase splitter with amplitude matching. A 45° split is achieved by tying together the inputs of two offset four-phase 90° phase splitters. The inventors assert that amplitude matching may be achieved by obtaining those inputs from an additional single four-phase 90° splitter.

### SUMMARY OF THE INVENTION

Embodiments of the present invention provide improved methods and devices for generating polyphase signals. In some embodiments, these signals are used as local oscillator (LO) signals for driving a pair of sub-harmonic mixers in a quadrature configuration.

Currently-available phase generators, such as the polyphase splitter described in U.S. Pat. No. 6,388,543 cited above, suffer from several limitations. For example, the phase-shifting networks used in such phase generators typically change their phase and amplitude response as a function of the load impedances applied to their outputs. Conventional phase generator configurations are also typically sensitive to component value variations that occur in IC (Integrated Circuit) fabrication processes. As a result, currently-available phase generator configurations are limited to narrow-band applications and process-corrected applications.

In embodiments of the present invention, the polyphase signal is produced by a novel polyphase network comprising phase-shifting elements arranged in a circularly-symmetrical configuration, as will be described below. The polyphase network converts one or more sinusoidal reference signals into a polyphase sequence of signals, having any phase increment of the form 360/n. Several phase generator stages may be cascaded to provide wide operation bandwidth and robustness to RFIC process variations.

Several circuit implementations of the phase-shifting elements are provided, including the use of an inverted reference signal to replace a 180° phase shift. This configuration offers lower insertion loss in comparison with alternative designs.

Embodiments of the present invention thus provide a balanced, equal-amplitude phase generator design that is robust in the presence of RFIC fabrication process variations and changing load conditions. Such a design is useful in a variety of applications, such as sub-harmonic quadrature mixers.

There is therefore provided, in accordance with an embodiment of the present invention, a phase generator including:

at least one input port for accepting a reference signal having a frequency;

a plurality of n output ports, n>4; and

a network of phase-shifting elements coupled in a circularly-symmetrical configuration having a symmetry increment of 360/n degrees between the at least one input port and the output ports, so as to generate at the output ports respective polyphase signals at the frequency, the polyphase signals having respective phases that are consecutive integer multiples of 360/n degrees.

In a disclosed embodiment, n=8.

In a disclosed embodiment, the network of phase-shifting elements includes resistor-capacitor (RC) circuits. Additionally or alternatively, the network of phase-shifting elements is implemented in an integrated circuit.

In another embodiment, the network of phase-shifting elements includes a first set of the elements providing a first phase shift, and a second set of the elements providing a second phase shift, the second phase shift differing by (360/n)-180 degrees from the first phase shift at the frequency. Additionally or alternatively, the elements in the first set include an inverter followed by a 360/n degree phase shifter, providing a combined phase shift of (360/n)-180 degrees at the frequency.

In yet another embodiment, the network of phase-shifting elements includes a cascaded connection of two or more networks of the phase-shifting elements.

In still another embodiment, the phase generator includes one or more pluralities of n buffer amplifiers coupled between the two or more networks of the phase-shifting elements. In another embodiment, each of the two or more networks has a zero at a different, respective frequency.

In another embodiment, the at least one input port includes multiple input ports, which are coupled to receive a set of real reference signals.

In still another embodiment, the phase generator includes one or more voltage-dividers for deriving the real reference signals from an external input signal.

There is also provided, in accordance with an embodiment of the present invention, a sub-harmonic quadrature mixer including:

a phase generator including:

at least one input port for accepting a reference signal having a frequency;

a set of eight output ports; and

a network of phase-shifting elements coupled between the at least one input port and the output ports, so as to generate at the output ports respective polyphase signals at the frequency, the polyphase signals having respective phases that are consecutive integer multiples of 45 degrees; and

a first mixer for converting a first RF (radio frequency) signal at an input frequency to a second RF signal at an output frequency, the first mixer accepting a first set of LO signals, including two or more of the eight polyphase signals having respective phases that are integer multiples of 90 degrees; and

a second mixer for converting the first RF signal at the input frequency to the second RF signal at the output frequency, the second mixer accepting a second set of LO signals, including two or more of the eight polyphase signals having respective phases that are integer multiples of 90 degrees, the respective phases of the second set differing by 45 degrees from the respective phases of the first set.

There is additionally provided, in accordance with an embodiment of the present invention, a method for signal generation including:

accepting one or more reference signals having a frequency; and

processing the reference signals using a network of phase-shifting elements arranged in a circularly-symmetrical configuration having a symmetry increment of 360/n degrees so as to generate a plurality of n output ports, n>4, respective polyphase signals at the frequency, the polyphase signals having respective phases that are consecutive integer multiples of 360/n degrees.

There is further provided, in accordance with an embodiment of the present invention, a method for sub-harmonic quadrature mixing, the method including:

accepting one or more reference signals having a frequency;

processing the reference signals using a network of phase-shifting elements so as to generate eight polyphase signals at the frequency, the polyphase signals having respective phases that are consecutive integer multiples of 45 degrees; and

converting a first RF (radio frequency) signal at an input frequency to a second RF signal at an output frequency, by:

mixing the first RF signal in a first mixer with a first set of two or more of the eight polyphase signals having respective phases that are integer multiples of 90 degrees; and

mixing the first RF signal in a second mixer with a second set of two or more of the eight polyphase signals having respective phases that are integer multiples of 90 degrees, the respective phases of the second set differing by 45 degrees from the respective phases of the first set.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a sub-harmonic quadrature mixer, in accordance with an embodiment of the present invention.

FIG. 2A is a block diagram that schematically illustrates a phase generator, in accordance with an embodiment of the present invention;

FIG. 2B is a schematic, pictorial illustration of the phase generator shown in FIG. 2A;

FIGS. 3A and 3B are block diagrams that schematically illustrate phase-shifting elements, in accordance with embodiments of the present invention;

FIG. 4 is a circuit diagram of a phase generator, in accordance with an embodiment of the present invention;

FIG. 5 is a block diagram that schematically illustrates cascaded phase generators and frequency generation circuitry, in accordance with an embodiment of the present invention;

FIG. 6 is a block diagram that schematically illustrates a frequency generation circuit, in accordance with an embodiment of the present invention; and

FIG. 7 is a circuit diagram of a phase generator, in accordance with an embodiment of the present invention.

### DETAILED DESCRIPTION OF EMBODIMENTS

### Sub-Harmonic Quadrature Mixer Description

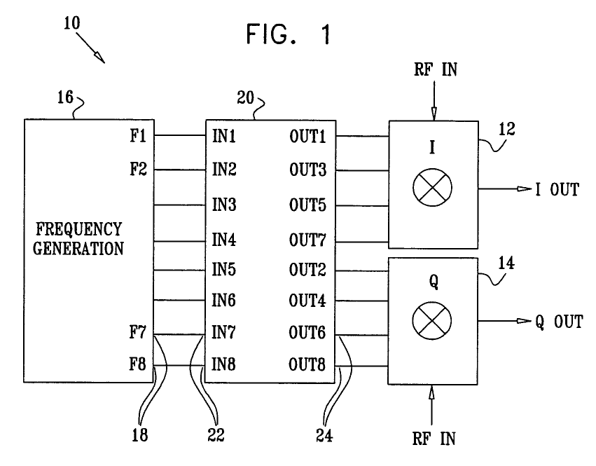

FIG. 1 is a block diagram that schematically illustrates a sub-harmonic quadrature mixer 10, in accordance with an embodiment of the present invention. Mixer 10 converts an RF (Radio Frequency) signal from one frequency to another. Quadrature mixers are commonly used in transmitter and receiver RF chains for performing up-conversion and down-conversion of signals. One of the advantages of quadrature mixers is that they suppress spurious image signals that are associated with frequency conversion. Using quadrature mixers typically relaxes the requirements for post-mixer filtering and simplifies the overall RF chain design.

The mixer shown in FIG. 1 is a down-converting second-order sub-harmonic quadrature mixer. Quadrature mixers of higher harmonic orders, as well as up-converting mixers, may also be implemented as embodiments of the present invention, as will be apparent to those skilled in the art.

Quadrature mixer 10 comprises two second-order sub-harmonic mixers 12 and 14 for down-converting the In-phase (I) and Quadrature (Q) components of the signal, respectively. Mixers 12 and 14 convert the RF input signal (marked as RF IN in FIG. 1) into IF (Intermediate Frequency) output signals (marked as IF OUT I and IF OUT Q in FIG. 1) by multiplying the RF input signal with the second harmonic of a sinusoidal LO (local oscillator) signal. In a second order sub-harmonic mixer, each mixer is driven by four LO signals having an incremental phase difference of 90° (i.e., 0°, 90°, 180° and 270°) at the LO frequency. Such a group of signals is referred to as a polyphase sequence having a 90° phase increment. To maintain a quadrature relationship between mixers 12 and 14, the four LO signals driving mixer 12 have a 45° phase offset compared to the four LO signals driving mixer 14 (i.e., 45°, 135°, 225° and 315°). The 45° offset between the two polyphase sequences causes the second harmonics of the LO signals to have a 90° phase offset required for quadrature. (For the general case of a sub-harmonic quadrature mixer of order N, the required phase offset is 90°/N.) Thus, driving mixers 12 and 14 jointly requires a polyphase sequence of eight LO signals having a phase increment of 45° (i.e., 0°, 45°, 90°, 135°, 180°, 225°, 270° and 315°) at the LO frequency.

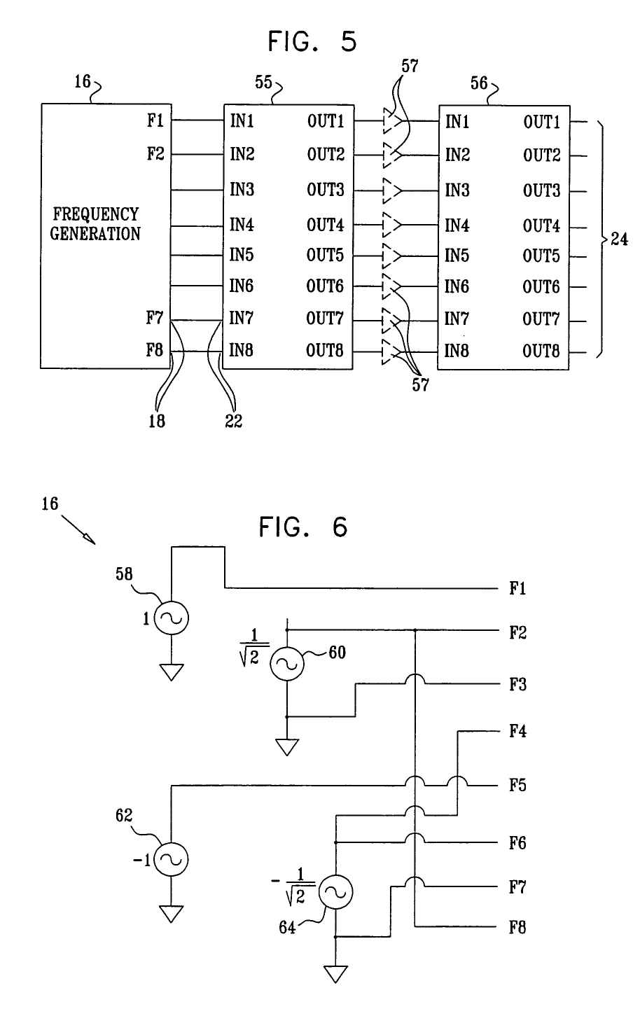

Mixer 10 further comprises a frequency generation circuit 16 and a phase generator 20 for generating the required eight LO signals. In some embodiments, circuit 16 comprises a single oscillator providing a sinusoidal reference signal at the LO frequency. In other embodiments, circuit 16 comprises several phase-synchronized oscillators, generating sinusoidal reference signals having different amplitudes, as will be explained in the description of FIG. 6 below. Circuit 16 provides the reference signals at reference outputs 18, driving inputs 22 of phase generator 20.

Phase generator 20 accepts the reference signals provided by circuit 16 and manipulates them to provide a polyphase sequence of eight LO signals having a 45° phase increment, at generator outputs 24. Four LO signals (having phases 0°, 90°, 180° and 270°) are used to drive mixer 12. The remaining four signals (having phases 45°, 135°, 225° and 315°) are used to drive mixer 14. It can be seen that the two conditions mentioned above are fulfilled: each mixer is driven by a polyphase sequence having a 90° phase increment, and the two mixers are driven by sequences having a relative 45° phase offset.

In an alternative implementation of sub-harmonic quadrature mixer 10, mixers 12 and 14 are each driven by two LO signals in anti-phase. The 45° phase offset between the LO signals driving mixers 12 and 14 is maintained. Thus, two LO signals having phases 0° and 180° drive mixer 12, while two LO signals having phases 45° and 225° drive mixer 14.

Before describing the inner structure of phase generator 20, the theory of polyphase sequence generation will now be explained in detail.

### Polyphase Sequence Generation

Phase generator 20 can be viewed as a polyphase network having eight inputs and eight outputs. The polyphase network is driven by a polyphase sequence comprising eight signals. A polyphase sequence is defined as a “clockwise sequence” if its phase increment is positive. Similarly, a polyphase sequence whose phase increment is negative is defined as an “counter-clockwise sequence,” referring to the direction of phase rotation in the complex, or polar, representation of the signals.

For example, the sequence {1,e^{-jπ/4},e^{-jπ/2},e^{-j3π/4},e^{-jπ}, . . . } is a clockwise sequence. The sequence {1,e^{jπ/4},e^{jπ/2},e^{j3π/4},e^{jπ}, . . . } is a counter-clockwise sequence. The direction of phase rotation is referred to as the polarity of the sequence. As described in the paper by Galal et al., cited above, a polyphase network may exhibit asymmetric response to sequences of opposite polarities. This sequence-discrimination property is used to generate polyphase sequences from a real reference signal, as will be explained below.

Phase generator 20 comprises a complex filter whose spectral response has a zero at a negative frequency (−f0), wherein f0 is equal to the LO frequency of the reference signals provided by circuit 16. In the explanation that follows, only the complex envelope of the signals is considered. The following table describes input and output signals of phase generator 20:

| | Actual | Sequence | | |
|---|---|---|---|---|
| Port | excitation | superposition | Sequence 1 = Output | Sequence 2 |
| 1 | 2 | 1 + 1 | 1 | 1 |
| 2 | \sqrt{2} | e^{jπ/4} + e^{-jπ/4} | e^{jπ/4} | e^{-jπ/4} |
| 3 | 0 | e^{jπ/2} + e^{-jπ/2} | e^{jπ/2} | e^{-jπ/2} |
| 4 | −\sqrt{2} | e^{j3π/4} + e^{-j3π/4} | e^{j3π/4} | e^{-j3π/4} |
| 5 | −2 | e^{jπ} + e^{-jπ} | e^{jπ} | e^{-jπ} |
| 6 | −\sqrt{2} | e^{j5π/4} + e^{-j5π/4} | e^{j5π/4} | e^{-j5π/4} |
| 7 | 0 | e^{j3π/2} + e^{-j3π/2} | e^{j3π/2} | e^{-j3π/2} |
| 8 | \sqrt{2} | e^{j7π/4} + e^{-j7π/4} | e^{j7π/4} | e^{-j7π/4} |

Inputs 22 of phase generator 20 are excited by the eight reference signals given in the second column of the table. Note that all eight reference signals are real, and their complex envelopes are therefore represented by real numbers. Each signal in the second column of the table may be mathematically represented as a superposition of two complex signals, as shown in the third column. Note that this representation comprises a superposition of two polyphase sequences—a clockwise sequence (shown separately as “sequence 1” in the fourth column) and a counter-clockwise sequence (shown separately as “sequence 2” in the fifth column).

Since phase generator 20 is a linear system, the response of the phase generator to the excitation signal (second column, or equivalently the third column) is equal to the sum of its responses to the two polyphase sequences (fourth and fifth columns) . Since the spectral response of the phase generator has a zero at frequency −f0, its response to the counter-clockwise polyphase sequence (fifth column of the table) is zero. Therefore, the response of the phase generator comprises only the clockwise sequence given in the fourth column.

To summarize, phase generator 20 is a complex filter that translates the eight real excitation signals {2, √2, 0, −\sqrt{2}, −2, −\sqrt{2}, 0, \sqrt{2}} into the polyphase sequence eight sinusoidal LO signals having a π/4 (45°) phase increment. The eight input values {2, \sqrt{2}, 0, −\sqrt{2}, −2, −\sqrt{2}, 0, \sqrt{2}} give the relative amplitudes of eight phase-synchronized sinusoidal reference signals that should be provided by frequency generation circuit 16 in order to produce the desired eight LO signals at outputs 24 of phase generator 20. Several exemplary configurations of circuit 16 providing the required excitation signals are given in the description of FIG. 6 below.

### Phase Generator Structure

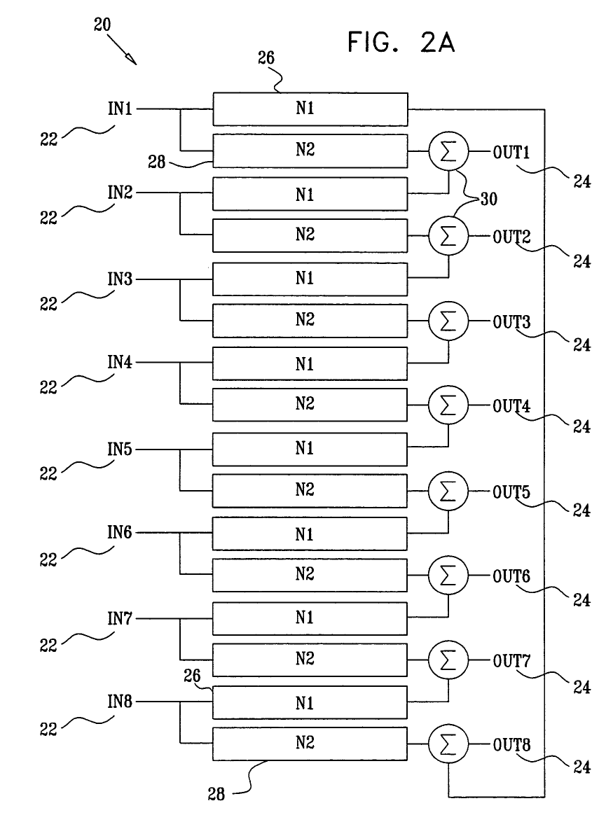

FIG. 2A is a block diagram that schematically illustrates phase generator 20, in accordance with an embodiment of the present invention. As described above, generator 20 receives the reference signals at inputs 22 and manipulates them to produce eight output signals having a 45° phase increment at outputs 24. Phase generator 20 comprises two sets of phase-shifting elements. Elements 26 of the first set (marked Ni) provide a phase shift of α+135°, compared to elements 28 of the second set (marked N2), which provide a phase shift of α° at the LO frequency. The outputs of the phase-shifting elements are combined using combiners 30 to produce output signals at outputs 24. The amplitude responses of element 26 and 28 are typically equal at the frequency of interest, so that each combiner 30 accepts and combines two equal magnitude signals.

The 135° phase difference between elements 26 and 28 causes the phase generator to attenuate the counter-clockwise polyphase sequence, as described above. Assume that a counter-clockwise sequence at the LO frequency having a 45° phase increment is applied to inputs 22 of the phase generator. Consider the signal at one of outputs 24 of the phase generator, for example OUT 3 in FIG. 2A. This signal is the sum of the signal at IN3 after being phase-shifted by α° using element 28, and the signal at IN4 after being phase-shifted by α+135° using element 26. Accumulating the phases, it can be seen that the two components reach combiner 30 with a phase difference of 180°. Therefore, the total signal at output OUT3 is zero. The same consideration applies to all eight outputs 24, resulting in full attenuation of the counter-clockwise sequence at the LO frequency.

The 135° phase-shifting difference between elements 26 and 28 is closely-related to the 45° phase increment of the polyphase sequence. The structure of phase generator 20 described herein may be generalized to produce polyphase sequences having any phase increment of the form 360°/n, wherein n is an arbitrary integer. In the general case, the phase-shifting difference between elements 26 and 28 is (180-360/n)° at the LO frequency. The example described herein assumes n=8. The generalization to other values of n may be used to produce quadrature sub-harmonic mixers of higher harmonic orders.

FIG. 2B is a schematic pictorial illustration of phase generator 20, shown here to illustrate the circular symmetry of the design presented in FIG. 2A. It can be seen that elements 26 and 28 are arranged in a circularly-symmetric configuration. In the context of the present patent application and in the claims, the term “circular symmetry” means that any cyclic shift to the order of the signals applied to inputs 22 causes a respective cyclic shift in the order of the signals at outputs 24. A circularly-symmetric configuration is said to have a symmetry increment of θ degrees if a cyclic shift of θ degrees to the input signals causes a respective cyclic shift of θ degrees of the outputs. The n=8 example shown in FIGS. 2A and 2B has a symmetry increment of 45 degrees.

A circular-symmetric configuration is beneficial, inter alia, since it produces equal amplitude output signals, independent of the loading of the respective outputs, as long as the load impedances are equal (in other words—as long as the load is also circularly-symmetric).

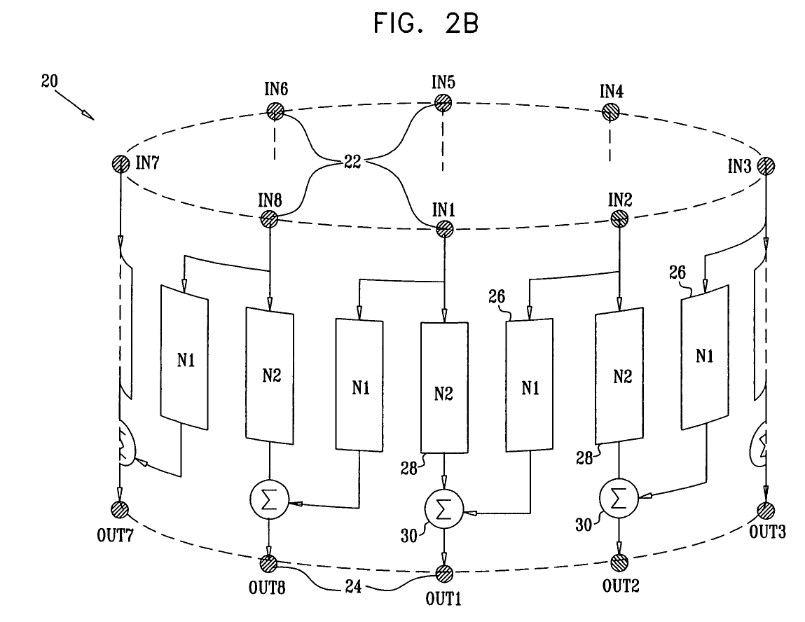

FIGS. 3A and 3B are block diagrams that schematically illustrate two alternative implementations of phase-shifting elements 26 and 28, in accordance with embodiments of the present invention.

In FIG. 3A, element 26 (marked N1) comprises an RC T-network comprising two capacitors 42 and a resistor 40. A typical normalized value for capacitors 42 is 1/(12.5·f0) Farads, and a typical normalized value for resistor 40 is 1 Ohm. Element 28 (marked N2) comprises a resistor 44, having a typical normalized value of 0.178 Ohms. Elements 26 and 28 implemented using these RC networks have equal amplitude responses and a relative phase difference of 135° at a normalized LO frequency of 1, used to simulate the circuit configuration of FIG. 3A. Combiner 30 sums the currents flowing through elements 26 and 28 to produce a combined current at the respective output 24. Note that the values of capacitors 42 and of resistors 40 and 44 may be scaled proportionally to suit implementation needs. Typically, the two RC networks of elements 26 and 28 are implemented inside an RFIC using fabrication techniques known in the art.

FIG. 3B shows an alternative implementation of phase-shifting elements 26 and 28. Element 28 again comprises resistor 44, having a typical value of 1 Ohm. Element 26 comprises an inverter 54, performing a 180° phase shift, followed by a capacitor 52 and a resistor 50 connected in series. If resistor 44 is set to 1 Ohm, then a typical normalized value for capacitor 52 is 1/(2πf0/\sqrt{2}) Farads, and a typical normalized value for resistor 40 is 1/\sqrt{2} Ohms. Again, these values may be scaled proportionally. Inverter 54 may be omitted by accepting an inverted (i.e., shifted by 180°) replica of the reference signal as input to element 26, as will be explained below. The main benefit of the configuration of FIG. 3B is the lower insertion loss of element 26. Having a lower insertion loss is particularly important in configurations that cascade several generators 20, as will be shown below.

Note that the two alternative circuit implementations of elements 26 and 28 in FIGS. 3A and 3B are shown solely by way of example. Other suitable designs of phase-shifting elements 26 and 28 meeting the criteria set forth hereinabove for phase generator 20 will be apparent to those skilled in the art.

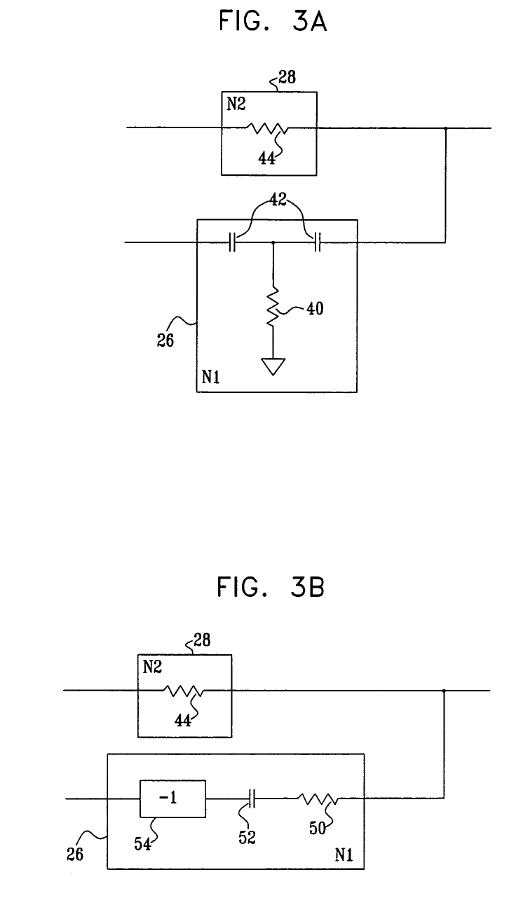

FIG. 4 is a circuit diagram of phase generator 20, in accordance with an embodiment of the present invention. This implementation uses the configuration of phase generator 20 that is shown in FIG. 2A and the configuration of phase-shifting elements 26 and 28 shown in FIG. 3B. As noted above, inverters 54 were replaced in the configuration of FIG. 4 by using inverted replicas of the appropriate reference signals.

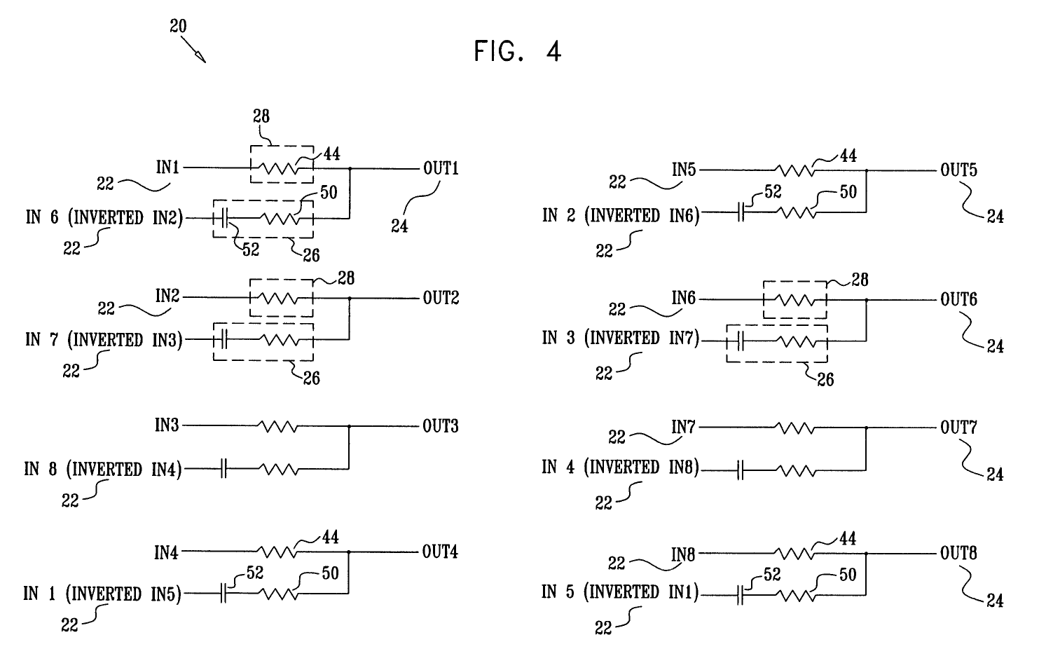

FIG. 5 is a block diagram that schematically illustrates cascaded phase generators 55 and 56 and frequency generation circuit 16, in accordance with an embodiment of the present invention. Reference outputs 18 of frequency generation circuit 16 drive inputs 22 of phase generator 55. The outputs of phase generator 55 drive the inputs of phase generator 56. The desired polyphase sequence is provided at outputs 24 of phase generator 56.

Phase generator 56 is implemented in a similar fashion to phase generator 20. The configuration of phase generator 55 varies according to the implementation of frequency generation circuit 16. In some embodiments, circuit 16 is configured to produce all eight reference signals, having the amplitudes and phases described above, and to provide these reference signals to the phase generator. Such an implementation of circuit 16 is shown in FIG. 6 below. In this case phase generator 55 is identical to phase generator 20 (and 56), as shown in FIG. 2A above.

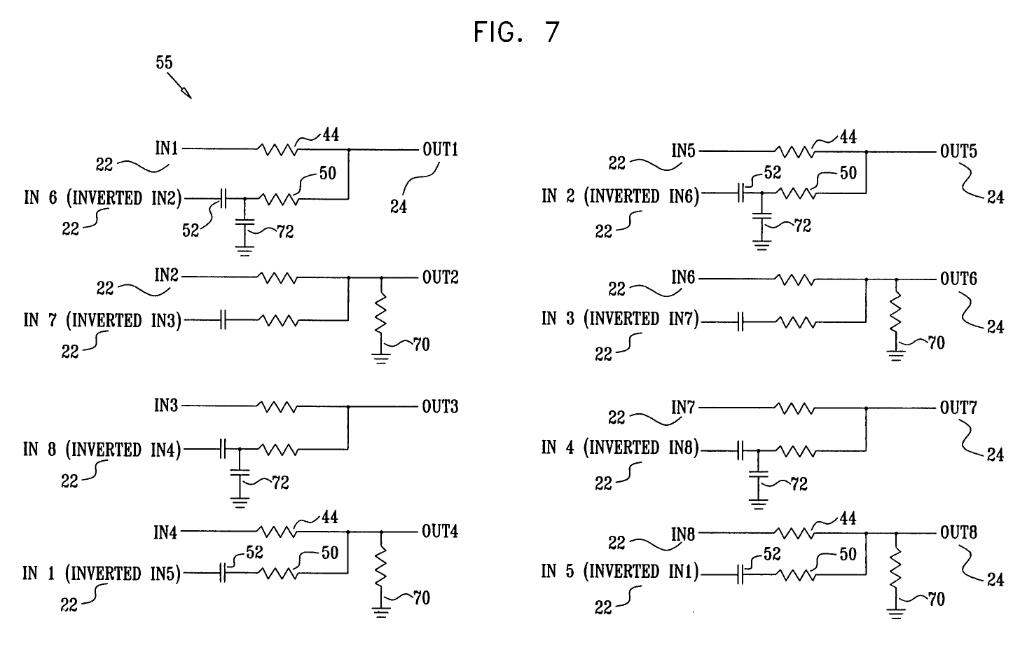

In other embodiments, circuit 16 produces only one external reference signal. In this case, phase generator 55 is similar to phase generator 20 (and 56), but also comprises voltage-dividers for generating the eight reference signals from the external reference signal. This configuration is explained in the description of FIG. 7 below.

In some applications it is beneficial to connect two or more phase generators in cascade in this manner. For example, each of the cascaded phase generators may have a zero at a different frequency. This configuration provides phase generation (in other words—attenuation of the counter-clockwise polyphase sequence) over a larger bandwidth, and also allows for process errors in the RFIC fabrication. In a typical CMOS process, for example, the actual values of the resistance-capacitance product (RC) may vary by as much as ±30%. This variation is translated into a similar variation in the spectral zero of the phase generator (frequency −f0). Having several cascaded phase generators causes the design shown in FIG. 5 to attenuate counter-clockwise polyphase sequences over a larger range of frequencies, making it more robust to process errors.

Optionally, the outputs of phase generator 55 are amplified using a set of buffer amplifiers 57, before driving the inputs of phase generator 56. Positioning the buffer amplifiers between the phase generator stages reduces the DC current consumption of the amplifiers, in comparison to a configuration in which the amplifiers are located at the output of the last stage in the cascade. Positioning amplifiers 57 between the stages also reduces the output noise level of the cascade. A low noise level is particularly desirable in some applications of polyphase phase generators, such as receiving antenna beam-forming networks.

While FIG. 5 shows two cascaded phase generators for the sake of clarity, a larger number of stages may be cascaded for better performance.

FIG. 6 is a block diagram that schematically illustrates frequency generation circuit 16, in accordance with an embodiment of the present invention. Circuit 16 comprises four oscillators 58, 60, 62 and 64, generating sinusoidal reference signals at the LO frequency f0. The oscillators are mutually phase-synchronized. Relative to oscillator 58, oscillators 60, 62 and 64 have relative amplitudes of 1/\sqrt{2}, −1 and −1/\sqrt{2}, respectively. (Negative amplitude means the respective oscillator has a 180° phase shift in respect to oscillator 58. Note also that normalized amplitudes are used for the sake of conceptual clarity. The actual voltages of the oscillators may be scaled proportionally to any suitable level, such as the excitation values 2, \sqrt{2}, −2 and −2 given in the second column of the table above.) As can be seen in FIG. 6, circuit 16 provides a set of eight real signals at outputs 18 (outputs marked F1, F2, . . . , F8), having amplitudes {1, 1/\sqrt{2}, 0, −1/\sqrt{2}, −1, −1/\sqrt{2}, 0, 1/\sqrt{2}} Volts. Multiplying these amplitudes by 2 yields the eight excitation signals {2, 2 ,0, −\sqrt{2}, −2, −\sqrt{2}, 0, 2}, required for driving inputs 22 of phase generator 20 so as to provide the polyphase sequence sinusoidal LO signals having a 45° phase increment, as shown above.

In an alternative design of circuit 16, the eight reference signals having amplitudes {1, 1/\sqrt{2}, 0, −1/\sqrt{2}, −1, −1/\sqrt{2}0, 1/\sqrt{2}} Volts may be produced using a single oscillator 58 that provides a single external reference signal and its inverse (180° phase-shifted replica) to phase generator 20. In this configuration circuit 16 comprises a single oscillator 58 having an amplitude of 1 Volt. The ±1/\sqrt{2} amplitudes are produced by using voltage dividers (shown in detail in FIG. 7 below) that provide the Thevenin equivalent of the required voltage level at each input 22, as is known in the art. The phase generator is configured as follows:
Inputs 22 IN1, IN2 and IN8 (as marked in FIG. 2A) are provided with the external reference signal from frequency generator circuit 16.
Inputs 22 IN3 and IN7 are connected to ground.
Inputs 22 IN4, IN5 and IN6 are provided with the inverted external reference signal from frequency generator circuit 16.
Input 22 IN2 and IN8 comprise suitable voltage dividers for converting the 11111 amplitude of the external reference signal to 1/\sqrt{2}.
Input 22 IN4 and IN6 comprise suitable voltage dividers for converting the “−1” amplitude of the inverted external reference signal to −1/\sqrt{2}.
   Note that for applications using cascaded phase generator stages, as shown for example in FIG. 5 above, voltage dividers are required only at the inputs of phase generator 55, the first stage in the cascade, and not in subsequent stages.

FIG. 7 is a circuit diagram of phase generator 55, in accordance with an embodiment of the present invention. The configuration of generator 55 is similar to phase generator 20 shown in FIG. 4, with the addition of voltage dividers enabling the use of a single external reference signal, as described above. Four resistors 70 form resistive voltage dividers together with the corresponding resistors 44, providing the ±1/\sqrt{2} amplitudes at inputs 22 labeled IN2, IN4, IN6 and IN8. Four capacitors 72 form capacitive voltage dividers together with the corresponding capacitors 52, providing the ±1/\sqrt{2} amplitudes at inputs 22 labeled IN6 (inverted IN2), IN8 (inverted IN4), IN2 (inverted IN6) and IN4 (inverted IN8).

Although phase generators are described in this patent application as part of an LO source driving a quadrature sub-harmonic mixer, the principles of this phase generation method may also be used in other applications requiring polyphase signal generation. Such applications include phase shifting circuits for antenna beam-forming and MPSK (M-ary Phase Shift Keying) signal generation circuits, for example.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1. A phase generator comprising:
at least one input port for accepting a reference signal having a frequency;
a plurality of n output ports, n>4; and
a network of phase-shifting elements coupled in a circularly-symmetrical configuration having a symmetry increment of 360/n degrees between the at least one input port and the output ports, so as to generate at the output ports respective polyphase signals at the frequency, the polyphase signals having respective phases that are consecutive integer multiples of 360/n degrees.

2. The phase generator according to claim 1, wherein the network of phase-shifting elements comprises resistor-capacitor (RC) circuits.

3. The phase generator according to claim 1, wherein the network of phase-shifting elements is implemented in an integrated circuit.

4. The phase generator according to claim 1, wherein the network of phase-shifting elements comprises a first set of the elements providing a first phase shift, and a second set of the elements providing a second phase shift, the second phase shift differing by (360/n)-180 degrees from the first phase shift at the frequency.

5. The phase generator according to claim 4, wherein the elements in the first set comprise an inverter followed by a 360/n degree phase shifter, providing a combined phase shift of (360/n)-180 degrees at the frequency.

6. The phase generator according to claim 1, wherein the network of phase-shifting elements comprises a cascaded connection of two or more networks of the phase-shifting elements.

7. The phase generator according to claim 6, and comprising one or more pluralities of n buffer amplifiers coupled between the two or more networks of the phase-shifting elements.

8. The phase generator according to claim 6, wherein each of the two or more networks has a zero at a different, respective frequency.

9. The phase generator according to claim 1, wherein the at least one input port comprises multiple input ports, which are coupled to receive a set of real reference signals.

10. The phase generator according to claim 9, and comprising one or more voltage-dividers for deriving the real reference signals from an external input signal.

11. The phase generator according to claim 1, wherein n=8.

12. A sub-harmonic quadrature mixer comprising:
a phase generator comprising:
at least one input port for accepting a reference signal having a frequency;
a set of eight output ports; and
a network of phase-shifting elements coupled between the at least one input port and the output ports, so as to generate at the output ports respective polyphase signals at the frequency, the polyphase signals having respective phases that are consecutive integer multiples of 45 degrees; and
a first mixer for converting a first RF (radio frequency) signal at an input frequency to a second RF signal at an output frequency, the first mixer accepting a first set of LO signals, comprising two or more of the eight polyphase signals having respective phases that are integer multiples of 90 degrees; and
a second mixer for converting the first RF signal at the input frequency to the second RF signal at the output frequency, the second mixer accepting a second set of LO signals, comprising two or more of the eight polyphase signals having respective phases that are integer multiples of 90 degrees, the respective phases of the second set differing by 45 degrees from the respective phases of the first set.

13. The mixer according to claim 12, wherein the network of phase-shifting elements is arranged in a circularly-symmetric configuration having a symmetry increment of 45 degrees.

14. A method for signal generation comprising:
accepting one or more reference signals having a frequency; and
processing the reference signals using a network of phase-shifting elements arranged in a circularly-symmetrical configuration having a symmetry increment of 360/n degrees so as to generate a plurality of n output ports, n>4, respective polyphase signals at the frequency, the polyphase signals having respective phases that are consecutive integer multiples of 360/n degrees.

15. The method according to claim 14, wherein the network of phase-shifting elements comprises resistor-capacitor (RC) circuits.

16. The method according to claim 14, wherein the network of phase-shifting elements is implemented in an integrated circuit.

17. The method according to claim 14, wherein processing the reference signals comprises applying a first set of the phase-shifting elements to provide a first phase shift, and applying a second set of the phase-shifting elements to provide a second phase shift, the second phase shift differing by (360/n)-180 degrees from the first phase shift at the frequency.

18. The method according to claim 17, wherein applying the first set comprises applying an inverter followed by a 360/n degree phase shifter so as to provide a combined phase shift of (360/n)-180 degrees at the frequency.

19. The method according to claim 14, wherein processing the reference signals comprises cascading two or more networks of the phase-shifting elements.

20. The method according to claim 19, wherein cascading the two or more networks comprises coupling one or more pluralities of n buffer amplifiers between the two or more networks of the phase-shifting elements.

21. The method according to claim 19, wherein each of the two or more networks has a zero at a different, respective frequency.

22. The method according to claim 14, wherein accepting the one or more reference signals comprises receiving a set of real reference signals.

23. The method according to claim 22, wherein receiving the set of real reference signals comprises applying one or more voltage-dividers to derive the real reference signals from an external input signal.

24. The method according to claim 14, wherein n=8.

25. A method for sub-harmonic quadrature mixing, the method comprising:
accepting one or more reference signals having a frequency;
processing the reference signals using a network of phase-shifting elements so as to generate eight polyphase signals at the frequency, the polyphase signals having respective phases that are consecutive integer multiples of 45 degrees; and
converting a first RF (radio frequency) signal at an input frequency to a second RF signal at an output frequency, by:
mixing the first RF signal in a first mixer with a first set of two or more of the eight polyphase signals having respective phases that are integer multiples of 90 degrees; and
mixing the first RF signal in a second mixer with a second set of two or more of the eight polyphase signals having respective phases that are integer multiples of 90 degrees, the respective phases of the second set differing by 45 degrees from the respective phases of the first set.

26. The method according to claim 25, wherein the network of phase-shifting elements is arranged in a circularly-symmetric configuration having a symmetry increment of 45 degrees.
